(19) United States
(12) Patent Application Publication
(10) Pub. No.: US 2009/0258287 A1
(43) Pub. Date: Oct. 15, 2009

(54) BATTERY COVER ASSEMBLY FOR ELECTRONIC DEVICE

(75) Inventor: ZHENG SHI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/194,623

(22) Filed: Aug. 20, 2008

(30) Foreign Application Priority Data
Apr. 10, 2008 (CN) 200810300976.5

(51) Int. Cl. H01M 2/10

(52) U.S. Cl. 429/100

(57) ABSTRACT

A battery cover assembly (12) for use in a portable electronic device (10) comprises a housing (14), a battery cover (16), and a button assembly (12). The housing (14) defines a receiving space (144) therein and has a edges (145) formed thereon. The edges (145) has a button chamber (147) defined therein. The battery cover (16) covers the receiving space (144) and comprises a locking portion (166) protruding toward the housing (14). The button assembly (12) is slidably received in the button chamber (147) and has a main body (122) and an elastic member (124). The main body (122) has a stopping portion (1231) projecting from one side thereof, the elastic member (124) is mounted to the main body (122). The stopping portion (1231) securely engages with the locking portion (166), wherein when pressing the main body (122), the elastic member (124) biases the battery cover (161) away from the housing (14).

### BACKGROUND

1. Field of the Invention

The present invention generally relates to battery cover assemblies and particularly to battery cover assemblies used in electronic devices.

2. Description of Related Art

Batteries are widely used in portable electronic devices, such as personal digital assistants (PDAs), cellular phones and so on. A latch structure is typically used with a battery cover to secure the battery within the electronic device. However, the battery cover tends to be damaged during disassembly, since large forces may be applied to the battery cover.

Therefore, there is a room for improved within the art.

### BRIEF DESCRIPTION OF THE DRAWINGS

Many aspects of the exemplary battery cover assembly for electronic device can be better understood with reference to the following drawings. These drawings are not necessarily drawn to scale, the emphasis instead being placed upon clearly illustrating the principles of the exemplary battery cover assembly and portable electronic device. Moreover, in the drawings like reference numerals designate corresponding parts throughout the several views. Wherever possible, the same reference numbers are used throughout the drawings to refer to the same or like elements of an embodiment.

FIG. 1 is an exploded, isometric view of part of a portable electronic device including a battery cover assembly according to an exemplary embodiment.

FIG. 2 is similar to FIG. 1 viewed from another angle.

FIG. 3 is an assembled view of the portable electronic device shown in FIG. 1.

FIG. 4 is a view of the portable electronic device after removing battery cove r.

FIG. 5 is a partial sectional view of the portable electronic device in FIG. 3.

### DETAILED DESCRIPTION OF THE EXEMPLARY EMBODIMENTS

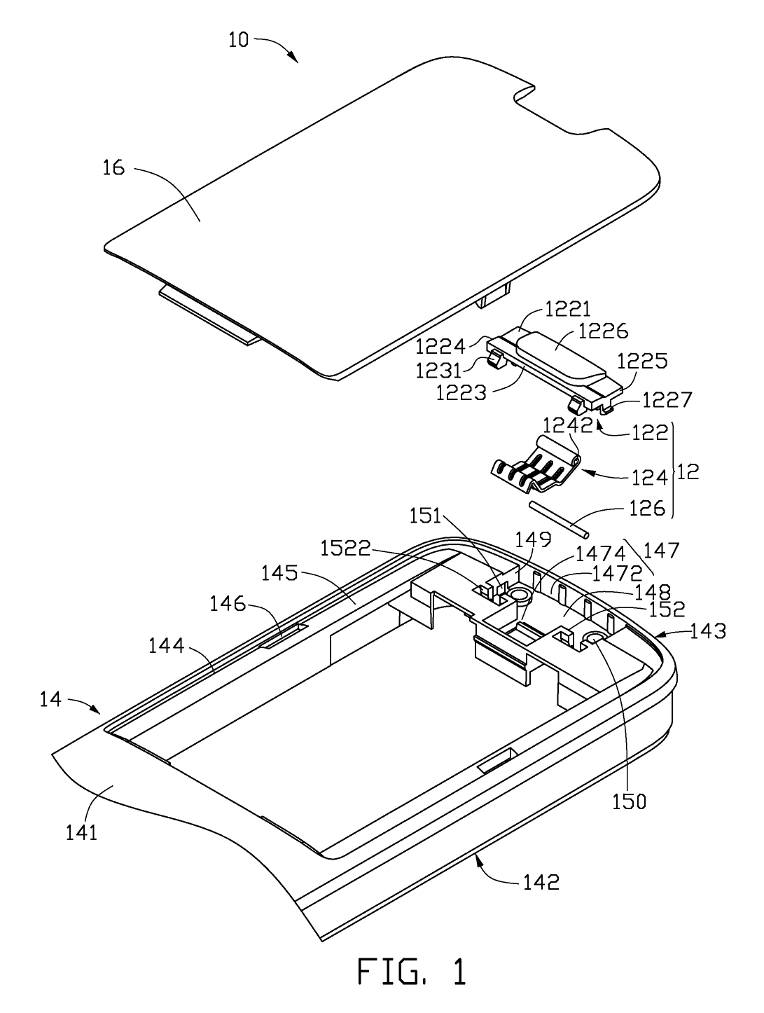

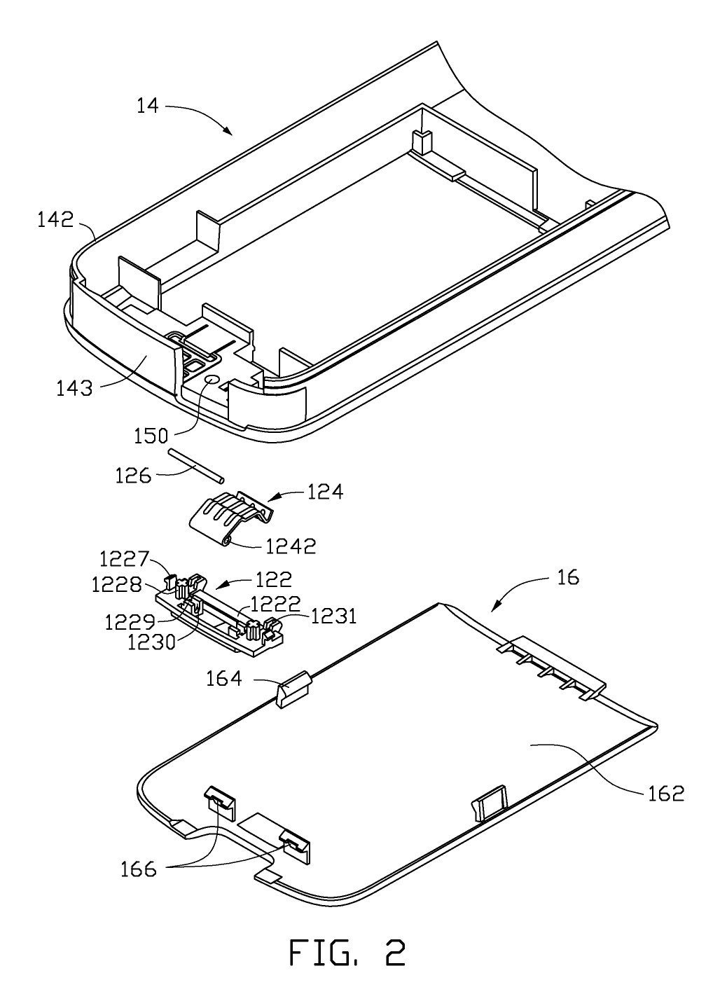

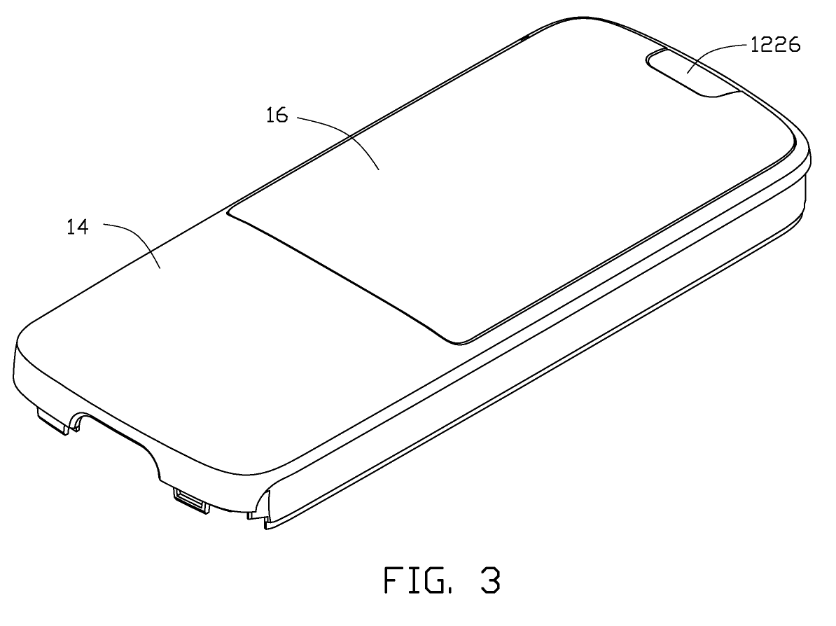

FIGS. 1-3 show an exemplary portable electronic device in the form of a mobile phone 10 (only a portion of which is shown) including a button assembly 12, a housing 14, and a battery cover 16.

The button assembly 12 includes a main body 122, an elastic member 124 and a shaft 126.

The main body 122 is substantially rectangular and includes a pressing surface 1221, an attaching surface 1222 opposite to the pressing surface 1221, a sidewall 1223, a first end 1224 and an opposite second end 1225. The pressing surface 1221 acts as the operating surface for users and has a centrally located pressing portion 1226. The attaching surface 1222 attaches to the housing 14.

The attaching surface 1222 has two sliding portions 1227 protruding therefrom. The two sliding portions 1227 are symmetrical with each other. One sliding portion 1227 is located adjacent to the first end 1224, and the other sliding portion 1227 is located adjacent to the second end 1225. Each of the sliding portions 1227 is substantially L-shaped and accommodated within the housing 14.

The main body 122 has two cruciform positioning poles 1228 protruding from the attaching surface 1222. The two positioning poles 1228 are aligned on the same axis located between the two sliding portions 1227. One positioning pole 1228 is located closer to the first end 1224 than the second end 1225, and the other positioning pole 1228 is located closer to the second end 1225 that the first end 1224.

The middle of the attaching surface 1222 has two fixed portions 1229 protruding therefrom. Each fixed portion 1229 has a U-shaped slot 1230 defined therein and configured for accommodating the shaft 126.

The main body 122 further has two stopping portions 1231. Each stopping portion 1231 projects from one side of the main body 122. As will be described and illustrated below, the stopping portions 1231 lock with corresponding locking portions 166 of the battery cover 16. Additionally, a portion of each stopping portion 1231 faces the locking portions 166 and is angled with respect to the locking portions 166.

The elastic member 124 is generally an arched sheet and has a mating hole 1242 defined in a first end, which is configured for securing the elastic member 124 to the main body 122. The mating hole 1242 is for accommodating the shaft 126 therein. A second end of the elastic member 124 resists the battery cover 16. The elastic member 124 has a tip For not numbered □ formed between the first and second ends of the elastic member 124 for resisting the housing 14.

The middle of the shaft 126 is accommodated in the mating hole 1242 and the two ends of the shaft 126 are securely received in the slots 1230.

The housing 14 includes a back panel 141, a front panel 142, and a first end 143 connecting the back panel 141 to the front panel 142.

The back panel 141 defines a receiving space 144 adjacent to the first end 143 and having edges 145 formed on the housing 14. The receiving space 144 accommodates the battery cover 16 therein. The edges 145 define a plurality of latching slits 146 for securing the battery cover 16 to the housing 14.

The edges 145 define a button chamber 147 near the first end 143 to accommodate the button assembly 12. The button chamber 147 includes a first chamber 1472 and a second chamber 1474. Accordingly, a bottom wall 148, two oppositely-faced sidewalls 149, and a connecting wall 152 facing to the first end 143 are formed in the housing 14 and cooperatively form the first chamber 1472. The second chamber 1474 passes through a middle portion of the connecting wall 152 and communicates with the first chamber 1472. A shape and size of the first chamber 1472 is substantially the same as the shape and size of the main body 122 of the button assembly 12 and configured for receiving the main body 122. A shape and size of the second chamber 1474 corresponds to the elastic member 124 and configured for receiving the elastic member 124.

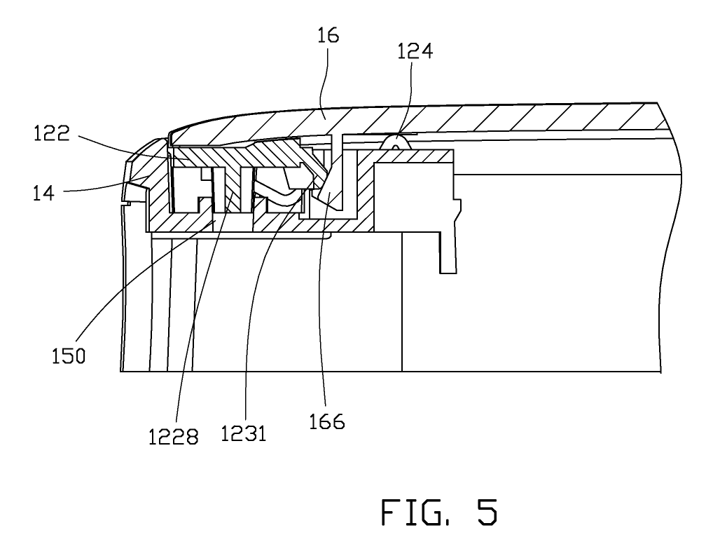

Referring to FIG. 5, the bottom wall 148 has two positioning holes 150 for accommodating the positioning poles 1228. Each sidewall 149 has a guiding slit 151 corresponding to and accommodating a sliding portion 1227. The housing 14 has a catch hole 1522 defined at each end of the connecting wall 152 for engaging the stopping portions 1231 of the main body 122.

The battery cover 16 is generally rectangular and has an attaching surface 162 facing the housing 14. The attaching surface 162 has a plurality of securing portions 164 used for securing with the latching slits 146. The locking portions 166 protrude from the attaching surface 162. A side portion of the locking portion 166 facing the stopping portion 1231, is angled with respect to the stopping portion 1231.

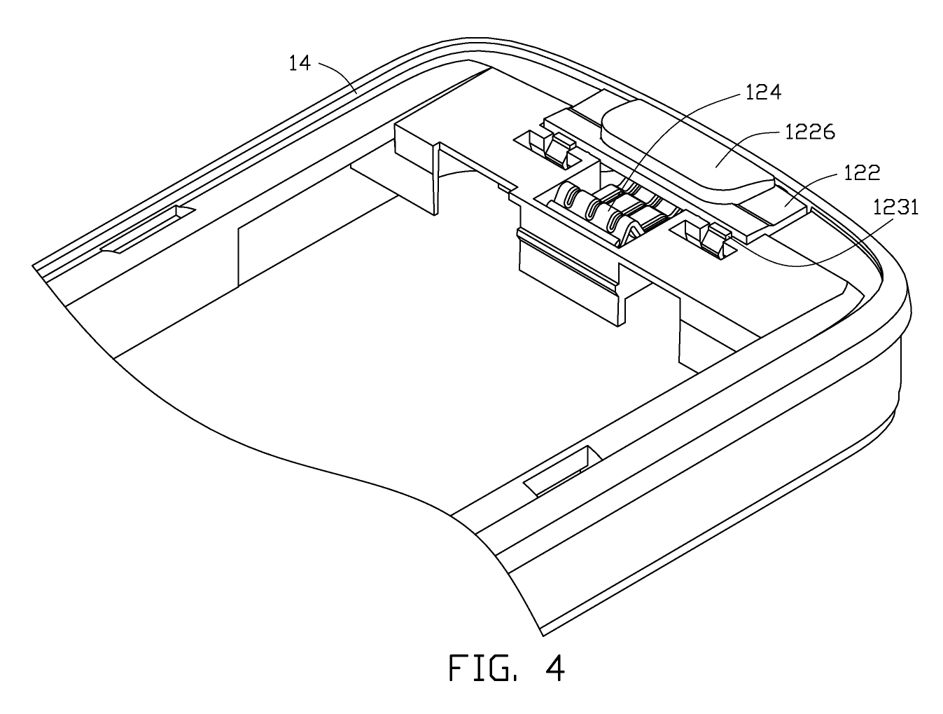

Referring to FIGS. 4 and 5, when assembling the button assembly 12 to the housing 14, the middle portion of the shaft 126 is received in the mating hole 1242 and the ends of the shaft 126 are secured to the fixed portions 1229. Each positioning pole 1228 of the button assembly 12 is received in one of the positioning holes 150. The sliding portion 1227 is accommodated in the guiding slit 151 and the stopping portions 1231 are caught in the catch holes 1522 so the main body 122 is received in the first chamber 1472. The elastic member 124 is received in the second chamber 1474 so the button assembly 12 is mounted in the button chamber 147. Therefore, the button assembly 12 is securely mounted in the housing 14.

When assembling the battery cover 16 to the housing 14, the battery cover 16 is aligned with the battery receiving space 144. The securing portions 164 are aligned with the latching slits 146. The locking portions 166 resist the stopping portions 1231. By pressing the battery cover 16 the locking portions 166 move along the stopping portions 1231 until the locking portions 166 reach the tip of the stopping portions 1231, and after that, lock with the stopping portions 1231. Thus, the battery cover 16 is assembled with the housing 14.

To detach the battery cover 16, the user applies a force to the pressing portion 1226 that moves the main body 122 along the wedge wall of the locking portion 166. As such, the locking portion 166 can be separated from the stopping portion 1231. During this stage, the first end of elastic member 124 securing to the main body 122 moves towards the housing 14. The second end of the elastic member 124 moves away from the housing 14 for driving the body of the battery cover 16 away from the housing 14. Therefore, the battery cover 16 is ejected from the housing 14.

As described, a slight press upon the button assembly 12 can release the locking relationship between the stopping portion 1231 and the locking portion 166, where the battery cover 16 is detached from the housing 14 by resisting of the elastic member 124.

It is to be understood, the elastic member 124 may be configured such that when a first end of the elastic member is pressed toward the housing, an opposite second end of the elastic member resists the battery cover away from the housing. The elastic member 124 may also be omitted. In this situation, the button assembly should include a resilient part for acting as an elastic member.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover assembly for use in a portable electronic device, comprising:
a housing defining a receiving space and having edges formed thereon, the edges defining a button chamber;
a battery cover covering the receiving space and comprising a locking portion protruding towards the housing; and
a button assembly being slidably received in the button chamber, the button assembly comprising a main body and an elastic member, the main body having a stopping portion projecting from one side thereof, the elastic member being mounted to the main body, the stopping portion securely engaging with the locking portion, wherein when pressing the main body, the elastic member biases the battery cover away from the housing.

2. The battery cover assembly as claimed in claim 1, wherein the elastic member biases the main body towards its original position.

3. The battery cover assembly as claimed in claim 1, wherein the elastic member is configured such that when a first end of the elastic member is pressed toward the housing, an opposite second end of the elastic member resists the battery cover away from the housing.

4. The battery cover assembly as claimed in claim 3, wherein when the first end of the elastic member is secured to the main body, the opposite second end of the elastic member resists the battery cover.

5. The battery cover assembly as claimed in claim 1, wherein the elastic member an arched sheet.

6. The battery cover assembly as claimed in claim 1, wherein the elastic member has a center portion resisting the bottom wall of the button chamber.

7. The battery cover assembly as claimed in claim 1, wherein the button assembly further includes a shaft, the elastic member defines a mating hole receiving the shaft therein, and the shaft is mounted to the main body so the elastic member is mounted to the main body.

8. The battery cover assembly as claimed in claim 1, wherein the main body has a surface facing the housing and a plurality of positioning poles protruding from the surface, the housing has a bottom wall defining the button chamber, and a number of positioning holes defined in the bottom wall for receiving the positing poles.

9. The battery cover assembly as claimed in claim 9, wherein the main body has two sliding portions protruding from the surface, the housing has two sidewalls facing each other, each of the two sidewalls has a guiding slit receiving a portion of the sliding portion.

10. The battery cover assembly as claimed in claim 1, wherein a sidewall of the locking portion facing the stopping portion is V-shaped.

11. The battery cover assembly as claimed in claim 1, wherein the button chamber includes a first chamber for receiving the main body therein and a second chamber communicating with the first chamber and receiving the elastic member therein.

12. The battery cover assembly as claimed in claim 11, wherein the housing has a connecting wall formed between the first chamber and the second chamber, the connecting wall has a catch hole defined at each end thereof for receiving the stopping portions of the main body.

13. A portable electronic device, comprising:
a housing having a button chamber defined therein;
a battery cover releasably mounted to the housing, and comprising a locking portion protruding towards the housing; and
a button assembly being slidably received in the button chamber, the button assembly comprising a stopping portion and a resilient part, the stopping portion being releasably latched with the locking portion, wherein when the button assembly is pressed to the housing, the button assembly urging the battery cover away from the housing undering the resilient part.

14. The portable electronic device as claimed in claim 13, wherein the resilient part is configured such that when a first end of the resilient part is pressed toward the housing, an opposite second end of the resilient part resists the battery cover away from the housing.

15. The portable electronic device as claimed in claim 14, wherein the resilient part has a center portion resisting the bottom wall of the button chamber.

16. The portable electronic device as claimed in claim 14, wherein the first end of the arched elastic sheet is secured to the main body, the opposite second end of the arched elastic sheet resists the battery cover.

17. The portable electronic device as claimed in claim 14, wherein the button assembly further includes a shaft, the arched elastic sheet defines a mating hole receiving the shaft therein, and the shaft is mounted to the main body so the arched elastic sheet is mounted to the main body.

18. The portable electronic device as claimed in claim 13, wherein the resilient part is an arched elastic sheet.

19. The portable electronic device as claimed in claim 13, wherein the main body has a surface facing the housing and has a number of positing poles protruding from the surface, the housing has a bottom wall to define button chamber, and a number of positing holes defined in the bottom wall for receiving the positing poles.

20. The portable electronic device as claimed in claim 19, wherein the main body has two sliding portion protruding from the surface, the housing has two sidewalls facing each other, each of the two sidewalls has a guiding slit receiving a portion of the sliding portion.
